(19) United States
(12) Patent Application Publication
(10) Pub. No.: US 2010/0224305 A1
(43) Pub. Date: Sep. 9, 2010

(54) Adhesive Having UV-Reactive Colorization

(76) Inventors: Stephen Paul Zadesky, Portola Valley, CA (US); Cameron Frazier, San Carlos, CA (US); Kurt Stiehl, San Jose, CA (US)

Correspondence Address: TI Law Group, 2055 Junction Avenue, #205, San Jose, CA, 95131-2116, US

(21) Appl. No.: 12/626,455

(22) Filed: Nov. 25, 2009

Related U.S. Application Data
(60) Provisional application No. 61/157,493, filed on Mar. 4, 2009.

(51) Int. Cl. B32B 38/00; C09J 189/00

(52) U.S. Cl. 156/64; 106/160.1

(57) ABSTRACT

An adhesive having a light-activated distinctive appearance is disclosed. The adhesive in the presence of a certain type of light can project a distinctive color. In one embodiment, an adhesive can have a light-activated colorization. The light used to activate the colorization can be Ultraviolet (UV) light. The adhesive can be used in an assembly and/or review process for consumer products to facilitate assembly and/or review of consumer products assembled at least in part using adhesive.

### CROSS-REFERENCE TO RELATED APPLICATION

This application is related to U.S. Patent Provisional Application No. 61/157,493, filed Mar. 4, 2009, and entitled “Adhesive Having UV-Reactive Colorization,” which is hereby incorporated herein by reference.

### BACKGROUND OF THE INVENTION

1. Field of the Invention

The present invention relates to an adhesive as well as techniques for assembling products using an adhesive.

2. Description of the Related Art

When manufacturing consumer electronic devices, it is common for parts of the devices to be assembled using adhesives, such as glue. However, control of placement and quantity of adhesive can be challenging, particularly with assembly of quality controlled consumer electronic devices. If the adhesive is misplaced or if too much adhesive is applied, then adhesive is present at places that it not desired. Although excess adhesive is less noticeable if clear, any excess adhesive is undesired as it detracts from the overall quality of the assembled consumer electronic devices. Additionally, the use of clear adhesive makes assembly and quality control more difficult because assembly and quality control workers are unable to easily ascertain where the adhesive has been applied or where there is excess adhesive.

Moreover, with small scale consumer electronic devices, such as personal digital assistants (PDAs), mobile phones, handheld digital media players, the scale of the components being assembled are generally smaller. With the smaller scale, the control over adhesive placement and quantity becomes even more difficult.

Thus, there is a need for improved techniques to yield enhanced quality when assembling product components using adhesives.

### SUMMARY

The invention, according to one embodiment, pertains to an adhesive having a light-activated distinctive appearance. The adhesive in the presence of a certain type of light can project a distinctive color. In one embodiment, an adhesive can have a light-activated colorization. The light used to activate the colorization can be Ultraviolet (UV) light. In one implementation, a UV dye can be incorporated into the adhesive to provide the light-activated colorization.

According to another embodiment, an assembly and/or review process for consumer products can use light in conjunction with an adhesive having a light-activated colorization to facilitate assembly and/or review of assembled consumer products. The light used to activate the colorization can be Ultraviolet (UV) light. Examples of consumer products include, for example, electronic devices. Examples of electronic devices include media players, mobile phones (e.g., cellular phones), user input devices (e.g., mouse, touch-sensitive device), PDAs, remote controls, notebooks, netbooks, tablet PCs, monitors, all in one computers, and the like.

The invention can be implemented in numerous ways, including as a method, system, device, or apparatus. Several embodiments of the invention are discussed below.

According to one embodiment, an adhesive can include at least a light-activated component that provides the adhesive with a distinctive visual appearance in the presence of light of particular wavelength.

According to another embodiment, a method for assembling a product can include, at least the operations of: providing a first part and a second part at an assembly area; dispensing adhesive onto one or both of the first part and the second part; joining the first part and the second part to form an assembled portion of the product using at least the dispensed adhesive; curing the dispensed adhesive; and thereafter illuminating the dispensed adhesive via a UV light source to facilitate examination of the assembled portion for adhesive irregularities.

According to still another embodiment, a method for assembling a product can include, at least the operations of: providing a first part and a second part at an assembly area; dispensing adhesive onto one or both of the first part and the second part; joining the first part and the second part to form an assembled portion of the product using at least the dispensed adhesive, the adhesive includes at least a light-activated component that provides the adhesive with a colorization in the presence of light of a particular wavelength; curing the dispensed adhesive; and thereafter illuminating the dispensed adhesive via light of the particular wavelength provided by a light source to facilitate examination of the assembled portion for adhesive irregularities.

### BRIEF DESCRIPTION OF THE DRAWINGS

The invention will be readily understood by the following detailed description in conjunction with the accompanying drawings, wherein like reference numerals designate like elements, and in which:

FIG. 1 illustrates a block diagram of a product assembly system according to one embodiment of the invention.

FIG. 2 is a flow diagram of a product assembly process according to one embodiment of the invention.

### DETAILED DESCRIPTION OF EMBODIMENTS OF THE INVENTION

The invention, according to one embodiment, pertains to an adhesive having a light-activated distinctive appearance. The adhesive in the presence of a certain type of light can project a distinctive color. In one embodiment, an adhesive can have a light-activated colorization. The light used to activate the colorization can be Ultraviolet (UV) light. In one implementation, a UV dye can be incorporated into the adhesive to provide the light-activated colorization.

According to another embodiment, an assembly and/or review process for consumer products can use light in conjunction with an adhesive having a light-activated colorization to facilitate assembly and/or review of assembled consumer products. The light used to activate the colorization can be Ultraviolet (UV) light. Examples of consumer products include, for example, electronic devices. Examples of electronic devices include media players, mobile phones (e.g., cellular phones), user input devices (e.g., mouse, touch-sensitive device), PDAs, remote controls, notebooks, netbooks, tablet PCs, monitors, all in one computers, and the like.

The invention can be implemented in numerous ways, including as a method, system, device, composition of matter or apparatus. Several embodiments of the invention are discussed below.

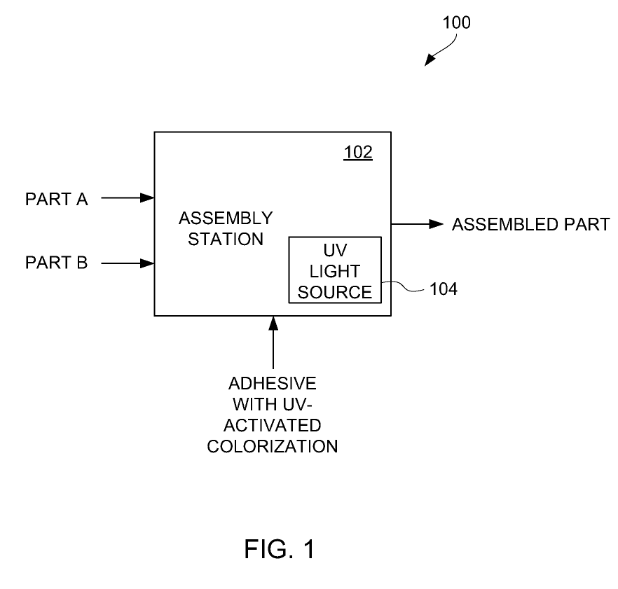

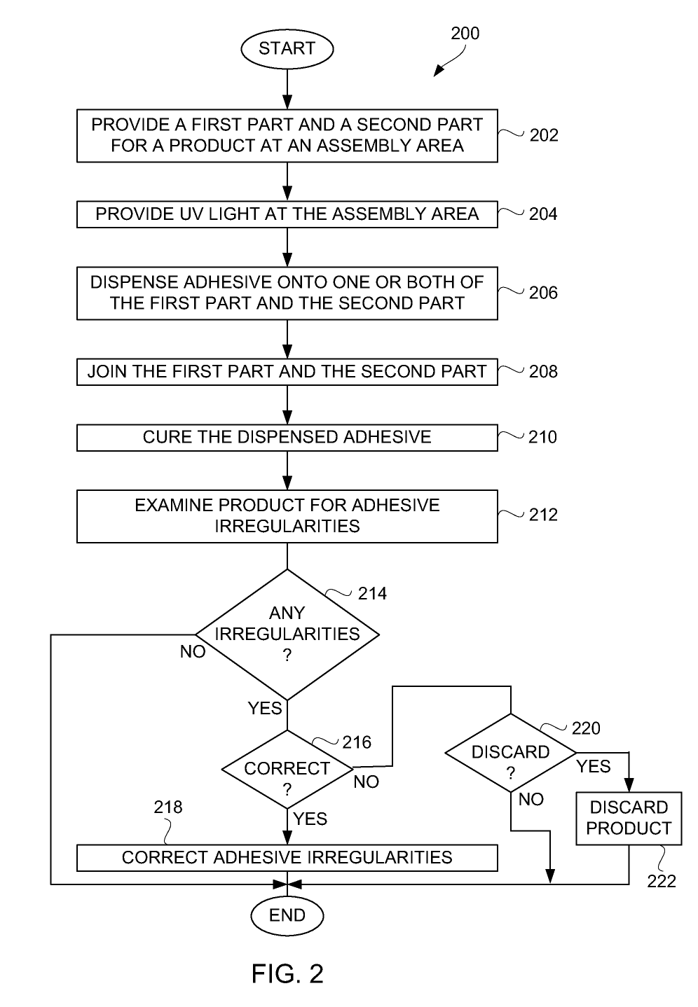

Embodiments of the invention are discussed below with reference to FIGS. 1-2. However, those skilled in the art will readily appreciate that the detailed description given herein with respect to these figures is for explanatory purposes as the invention extends beyond these limited embodiments.

FIG. 1 illustrates a block diagram of a product assembly system 100 according to one embodiment of the invention. The product assembly system 100 can be used in a product manufacturing environment in which products (namely, consumer electronic products) are assembled.

The product assembly system 100 includes an assembly station 102. The assembly station 102 serves to form an assembled part from a plurality of parts. The parts are components of a product being assembled. Typically, but not necessarily, the parts are parts of a housing or external surface of the product. In this embodiment, the parts being assembled include at least a part A and a part B. In forming the assembled part, the part A and the part B can be joined using at least in part an adhesive. In other words, adhesive is used in some way to join the part A and the part B, however, other approaches (e.g., snaps, latches, screws, detents, friction, etc.) can also be used. According to one embodiment, the adhesive is an adhesive that includes UV-activated colorization.

The assembly station 102 can also provide a UV light source 104. While the assembled part is being assembled from the part A and the part B at the assembly station 102 using the adhesive, the UV light source 104 can provide UV lighting on the adhesive. Since the adhesive has UV-activated colorization, the adhesive is distinctively illuminated when subjected to UV lighting. Advantageously, when the adhesive is distinctively illuminated, the adhesive becomes easier to manipulate and evaluate for proper placement and quantity, thereby aiding in the production of assembled parts. Additionally or alternatively, quality control for the adhesive usage can be rendered more efficient and reliable through us of adhesive that is distinctively illuminated.

In some cases consumer electronic products parts are to be precisely joined together with an adhesive. For cosmetic reasons, the adhesive is often translucent (i.e., clear) so that it does not impact the appearance of the product. However, when attempting to assemble parts with translucent adhesive, it is difficult to insure proper placement and quantity of adhesive. Also, with translucent adhesive it is difficult to perform quality control as to the adhesive, such as whether there is any exposed excess adhesive (i.e., adhesive overflow). Quality control often would reject assembled parts having exposed excess adhesive that detracts from appearance and quality of the assembled part.

The assembly station 102 includes the UV light source 104 to induce distinctive illumination of the adhesive. Specifically, the UV light can be directed over the adhesive areas so that the adhesive is distinctively illuminated. For example, although the adhesive is normally translucent (or transparent), once the UV light is imposed, the adhesive (being disposed or already disposed) can become at least partially opaque and project a color. As a result, the adhesive can be rendered readily visible in the presence of UV light.

In one embodiment, the adhesive with UV-activated colorization can include a UV dye. In such an embodiment, when UV light is received on the adhesive, the UV dye within the adhesive projects the color of the UV dye. In other words, the adhesive is normally translucent (i.e., clear) but in the presence of UV light becomes opaque with a distinct color. Once colorized by the UV light, adhesive can be (i) dispensed with visual feedback as to the placement and quantity of adhesive being applied, or (ii) examined as to the placement and quantity of adhesive already applied. Subsequently, when the UV light is removed, the adhesive is again translucent (i.e., clear). Thereafter, if the assembled undergoes a separate quality review, UV light can again be used to colorize the adhesive so as to facilitate quality review of the adhesive. This, for example, allows overflow regions of adhesive to be easily located.

In one embodiment, the adhesive can be formed from a composition that includes UV dye. In another embodiment, the UV dye can be introduced into the adhesive when it is dispensed (e.g., mixed on being dispensed). In still another embodiment, the UV dye can be applied to the adhesive before, during or after curing. In any case, the amount of UV dye used is at least equal to the amount needed to produce the desired colorization, i.e., point where it is visually distinctive (e.g., able to be seen by an assembler).

Examples of adhesives are cyanoacrylate, UV cure, thermal, etc. The adhesive can, for example, be a glue. The glue can be applied in a liquid form onto one or more parts being joined and then the glue becomes solid when cured. For example, the glue may be dispensed between two parts in a liquid form and then cured with the two parts held together so as to form a single solid structure. The glue can be selectively placed at glue joints or can be continuously applied along an entire glue joint or interface. Once cured, the glue having light-activated colorization can change its color when illuminated with light of a predetermined wavelength range (e.g., UV wavelength).

In other embodiments, the adhesive can provide light-activated colorization without use of UV dye. For example, light absorbing particles particular to a specific type of light may be introduced into the adhesive. As another example, light reflective particles (e.g., light florescent particles) particular to a specific type of light may be introduced into the adhesive.

The parts being joined by the adhesive can vary widely. In general, any parts that are used in a consumer product being assembled can be secured relative to each other using at least an adhesive (e.g., glue). The parts can be internal or external parts. Examples of parts that can be assembled or joined together include housings, sides, supports, covers, retaining structures, components, etc.

FIG. 2 is a flow diagram of a product assembly process 200 according to one embodiment of the invention. The product assembly process 200 can, for example, be performed at an assembly system having one or more assembly or review stations.

The product assembly process 200 provides 202 a first part and a second part for a product at an assembly area. UV light is also provided 204 at the assembly area. Next, adhesive is dispensed 206 onto one or both of the first part and the second part. The first part and the second part can then be joined 208. The dispensed adhesive is then cured 210. The first part and the second part have now been joined through use of adhesive.

To provide quality review (e.g., quality control) the product assembly process can also include additional operations for quality review. These additional operations for quality review can be provided at the assembly area or a separate process or station. According to one embodiment, after the dispensed adhesive has cured 210, the product can be examined 212 for adhesive irregularities. Here, by use of the UV light, the dispensed adhesive can be easily examined since the UV light causes the adhesive to project a particular color. A decision 214 can then determine whether there are any irregularities with the dispensed adhesive. When the decision 214 determines that there are irregularities, then a decision 216 can determine whether the one or more irregularities are to be corrected. If the one or more irregularities are to be corrected, then the adhesive irregularities are corrected 218. For example, excess adhesive can be removed from the product. On the other hand, if the one or more irregularities are not to be corrected, a decision 220 can determine whether the product should be discarded. If the decision 220 determines that the product should be discarded, the product can be discarded 222. Alternatively, if the decision 220 determines that the product should not be discarded, then the product assembly process 200 ends without discarding the product. Also, if there are no adhesive irregularities, then product assembly process 200 can by pass the blocks 216-222 and end.

The techniques described herein may be applied to a variety of consumer products, such as electronic devices including but not limited handheld electronic devices, portable electronic devices and substantially stationary electronic devices. By way of example, and not by way of limitation, the electronic devices may correspond to media players, mobile phones (e.g., cellular phones), user input devices (e.g., mouse, touch-sensitive device), PDAs, remote controls, notebooks, netbooks, tablet PCs, monitors, all in one computers and the like.

Although only a few embodiments of the invention have been described, it should be understood that the invention may be embodied in many other specific forms without departing from the spirit or the scope of the invention. By way of example, the operations associated with the methods of the invention may vary widely. Operations may be added, removed, altered, combined, and reordered without departing from the spirit of the scope of the invention.

The various aspects, features, embodiments or implementations of the invention described above can be used alone or in various combinations.

While this specification contains many specifics, these should not be construed as limitations on the scope of the disclosure or of what may be claimed, but rather as descriptions of features specific to particular embodiment of the disclosure. Certain features that are described in the context of separate embodiments can also be implemented in combination. Conversely, various features that are described in the context of a single embodiment can also be implemented in multiple embodiments separately or in any suitable subcombination. Moreover, although features may be described above as acting in certain combinations, one or more features from a claimed combination can in some cases be excised from the combination, and the claimed combination may be directed to a subcombination or variation of a subcombination.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. An adhesive, comprising a light-activated component that provides said adhesive with a distinctive visual appearance in the presence of light of particular wavelength.

2. An adhesive, comprising a light-activated component that provides said adhesive with a colorization in the presence of light of particular wavelength.

3. An adhesive, comprising an UV-activated material, wherein said adhesive is translucent when not subjected to UV light, and wherein said adhesive is at least partially opaque when subjected to UV light.

4. An adhesive as recited in claim 3, wherein said adhesive projects a color when subjected to UV light.

5. An adhesive as recited in claim 4, wherein the color is a predetermined color.

6. An adhesive as recited in claim 5, wherein the predetermined color is dependent on the UV-activated component.

7. An adhesive as recited in claim 3, wherein the UV-activated component comprises a dye.

8. A method for assembling a product, comprising:
providing a first part and a second part at an assembly area;
dispensing adhesive onto one or both of the first part and the second part;
joining the first part and the second part to form an assembled portion of the product using at least the dispensed adhesive;
curing the dispensed adhesive; and
thereafter illuminating the dispensed adhesive via a UV light source to facilitate examination of the assembled portion for adhesive irregularities.

9. A method as recited in claim 8, wherein the UV light source is provided at the assembly area.

10. A method as recited in claim 8, wherein the UV light illuminates the dispensed adhesive while said dispensing of the adhesive.

11. A method as recited in claim 8, wherein the UV light is provided while the assembled portion is being examined for adhesive irregularities.

12. A method as recited in claim 8, wherein the adhesive comprises a light-activated component that provides the adhesive with a distinctive visual appearance in the presence of UV light.

13. A method as recited in claim 8, wherein the adhesive comprises a light-activated component that provides the adhesive with a colorization in the presence of UV light.

14. A method as recited in claim 8, wherein the adhesive comprises an UV-activated material, wherein the adhesive is translucent when not subjected to UV light, and wherein the adhesive is at least partially opaque when subjected to UV light.

15. A method as recited in claim 14, wherein the adhesive projects a color when subjected to UV light.

16. A method as recited in claim 15, wherein the color is a predetermined color.

17. A method as recited in claim 16, wherein the predetermined color is dependent on the UV-activated component.

18. A method as recited in claim 14, wherein the UV-activated component comprises a dye.

19. A method as recited in claim 8, wherein the product is an electronic device.

20. A method as recited in claim 8, wherein the product is a portable electronic device.

21. A method for assembling a product, comprising:
providing a first part and a second part at an assembly area;
dispensing adhesive onto one or both of the first part and the second part;
joining the first part and the second part to form an assembled portion of the product using at least the dispensed adhesive, the adhesive includes at least a light-activated component that provides the adhesive with a colorization in the presence of light of a particular wavelength;
curing the dispensed adhesive; and
thereafter illuminating the dispensed adhesive via light of the particular wavelength provided by a light source to facilitate examination of the assembled portion for adhesive irregularities.
